(19) United States
(12) Patent Application Publication
(10) Pub. No.: US 2012/0167006 A1
(43) Pub. Date: Jun. 28, 2012

(54) METHOD AND SYSTEM FOR USER INTERFACE QUICK FILTER

(76) Inventors: Peter Tillert, Bad Schoenborn (DE); Tahar El Idrissi-Lamghari, Walldorf (DE)

(21) Appl. No.: 12/979,840

(22) Filed: Dec. 28, 2010

(51) Int. Cl. G06F 3/048

(52) U.S. Cl. 715/810

(57) ABSTRACT

According to some embodiments, an initial set of data is presented in a user interface; an indication of a selection of a sub-set of the initial set of data is received, the selection being made by directly selecting a portion of the initial set of data in the user interface; automatically determining at least one query statement based on the received indication of the selection of the sub-set of the initial data; and executing the at least one query statement against a collection of data to produce a result set of data. The at least one query statement functions to include data items similar to the selection of the sub-set of the initial data, exclude data items similar to the selection of the sub-set of the initial data, and combinations thereof.

### FIELD

Some embodiments relate to a user interface. More specifically, some embodiments provide a user interface method and system for filtering data presented in the user interface.

### BACKGROUND

A computer display may include a user interface to visually display information and data to a user. The information and/or data may be represented in the user interface by one or more user interface elements. The user interface elements may include text, tables, icons and other graphics, list, and other visual representations such as, for example, animations. The design and organization of a user interface may be configured or optimized to enhance the viewing of the data and other user interface elements therein. In some instances, an objective of user interface design may be to present data and other information in manner in which the displayed data and other information can communicate with a viewing user of the user interface. As an example, lists, tables, graphs, and charts may be utilized to present data in a user interface.

In some instances, the mere volume of data included and presented in a user interface may tend to obscure the data such that a viewer of the user interface may have difficulty in viewing, and more importantly, understanding the nature and characteristics of the presented data. In some environments, including business contexts, it may be crucial for a user to quickly and efficiently understand and recognize the meaning of, for example business data and how that data relates to, for example, a business entity or organization. In other instances, the data presented in the user interface is not exactly the type or scope of information that the user may need to in order to make an analysis or decision. For example, the presented data may include more than or less than the types of data the user needs for their understanding, analysis, and decision-making regarding the data presented in the user interface.

Accordingly, a method and mechanism for efficiently filtering data presented in a user interface based on a selection of data items in a user interface are provided by some embodiments herein.

### BRIEF DESCRIPTION OF THE DRAWINGS

FIG. 1 is a flow diagram of a process according to some embodiments.

FIG. 2 is a flow diagram of a process according to some embodiments.

FIGS. 3A-3C are illustrative depictions of user a user interface, showing various aspects of some embodiments herein.

FIG. 4 is a block diagram of a system according to some embodiments.

FIG. 5 is a block diagram of a system according to some embodiments.

### DETAILED DESCRIPTION

A computer system, device, application, or service may be used to generate a query statement or function, execute the query statement against a collection of data, and display the result of executing the query statement or function. In some instances, the number of data items (i.e., quantity) in the result of the query execution may be more than a person or organization can efficiently analyze or even desire to analyze. For example, the data results presented in a user interface may tend to clutter to user interface. In some instances, the scope of the query result is either too narrow or too broad for a person, organization, or other entity's desires or needs. That is, the quality of the query result may not match the desires or needs of the person, organization, or entity for which the query result is provided.

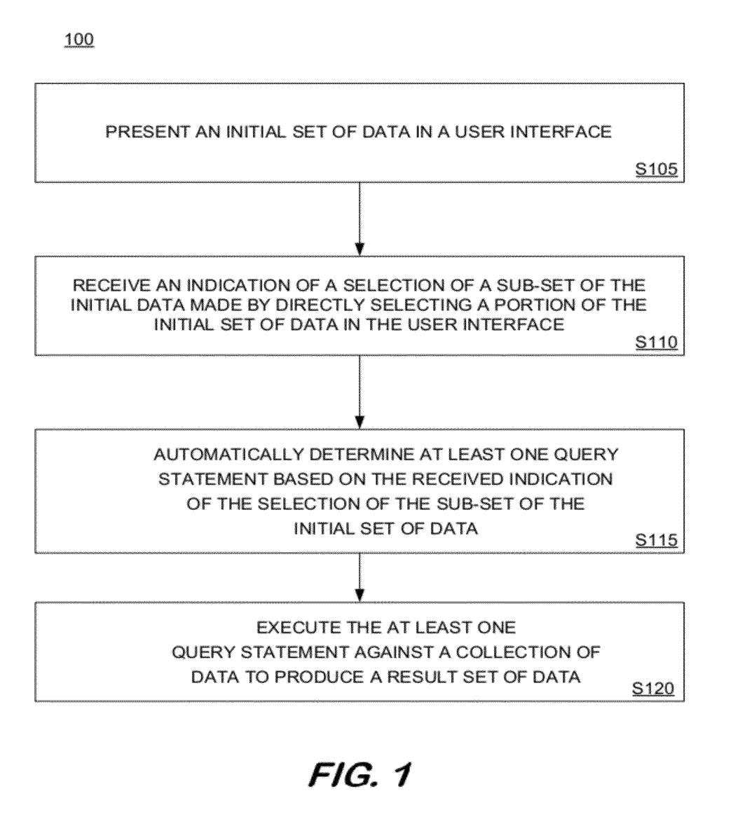

Some embodiments herein are associated with systems and methods for providing query results filtered to meet a user's search expectations, whether related to quantity, quality, or other aspects of the scope of the query result. FIG. 1 is an example of a flow diagram of a process 100 in accordance with some embodiments herein. At S105, an initial set of data is presented to a user of a computer system, device, application, or service via a user interface. The initial set of data may itself be the result of a previous search or query. In some aspects, the initial set of data may relate to applications and services in various business areas, such as Customer Relation Management (CRM), Supplier Relation Management (SRM), finances, etc. In some aspects, the initial set of data may relate to data provide through a web service, such as a search engine. In accordance with aspects herein, the user interface may be implemented using any number of programming languages and/or techniques, such as Web Dynpro, Java, the Advanced Business Application Programming (ABAP) language, and other languages. In some embodiments, the initial set of data may relate to an enterprise that might store and access business information in a number of different ways. For example, an enterprise might store a substantial amount of information about production, sales, human resources, etc. in one or more database structures created by a business service provider (e.g., SAP AG). The initial set of data may be provided to a user in a user interface as the result of the user's initial request for data related to a particular business function and/or organization. The initial request may comprise a query of a collection of data.

In some instances, the scope of the initial set of data may not be exactly what the user desires. The scope of the initial data may depart from the user's expectations in terms of the number of data items and the focus (or lack of focus) of initial set of data. Thus, the user may want to further filter the initial set of data in an effort to obtain data items more compatible with the user's desires, needs, and expectations. In some instances, the user is able to discern the type and scope of data results they desire after viewing the initial set of data. For example, the user may view the initial set of data and quickly and efficiently recognize that some of the initial data is relevant to their needs.

At S110, a selection of a sub-set of the initial set of data is received from the user. The selected sub-set of the initial set of data will be used to derive a filter to screen the initial set of data.

In some embodiments, the sub-set of the initial set of data is selected or otherwise identified by a user directly marking, selecting, or choosing the sub-set of the initial data in the user interface. The user interface that provides a means or mechanism for presenting the initial set of data to the user may also be the mechanism through which the user indicates and selects the sub-set of the initial set of data. In some embodiments, the user need not navigate to a different screen or display panel of the user interface in order to make their selection(s) of the sub-set of data from the initial set of data. The user may select the sub-set of data directly from the user interface screen, panel, or window in which the initial set of data was presented. Furthermore, the user may not need to use a specific tool or command to indicate the sub-set of data. In accordance with embodiments herein, the user may indicate a sub-set of the initial set of data presented via the user interface by using a mouse, trackpad, trackball or other like devices associated with a graphical user interface. In some embodiments, the user may indicate the selection of the sub-set of the initial set of data by touching a touchscreen of touch user interface.

In some embodiments, it is noted that the user does not provide or enter text to indicate the selection of the sub-set of the initial set of data. In some embodiments, the user may select one or more data items from the initial set of data presented in the user interface. For example, in some instances a user may select the sub-set of the initial data by manipulating a cursor around various portions of a user interface display and highlighting or choosing specific portions of the user interface display. Even in an instance the user uses a keyboard or keypad associated with the user interface to move around the user interface, arrow keys of the keyboard or keypad may be used to manipulate the movement of a cursor or other user interface element, while text entry keys may not be used since the entry of text to indicate or make the selection of the sub-set of data is not supported in some embodiments. In this manner, the user does not enter any alpha-numeric characters or a string of characters in selecting the sub-set of the initial data. In some embodiments, the user may select various data items presented in the user interface, including text items, tabular items, icons, and other graphical elements. Accordingly, the selection process may eliminate the need for text entry, thereby reducing the need for a user to be concerned with such data entry and/or an opportunity for data entry mistakes common with such data entries.

At S115, process 100 proceeds to determine at least one query statement or function based on the indication of the selected sub-set of data received via the user interface. The query statement or function may be determined automatically by a system, subsystem, application, service, or program based on the sub-set of selected data in response to the selection of the sub-set of data items. In general, the query statement is a precise request for the retrieval of information from a database, system, or data store matching the parameters specified in the query statement. The query statement or function may include one or more query statements or functions or calls to a query process, service, or operation that may individually and collectively operate to implement a query or search function in accordance with embodiments herein. The parameters of the query statements, functions, processes, services, or operations may be derived from the selected sub-set of data. The terms and conditions of the query statements, functions, and other functional implementations to carry out the query may be based on the data items selected directly in the user interface by the user.

In some embodiments, the selected sub-set of data chosen from the initial data presented on or in the user interface may be of the type of data the user wants or desires included in a query result. Accordingly, the query statement or function determined based on the selected sub-set of data should provide results that include similar or the same types of data items. In some embodiments, the selected sub-set of data chosen from the initial data presented on the user interface may be of the type of data the user does not want to review or desires to have presented to them. Accordingly, the query statement or function determined based on this selected sub-set of data should provide results that do not include (i.e., exclude) the types of data items that are the similar or the same as the selected sub-set of data.

At S120, the query derived from the selected sub-set of data items is executed against a collection of data. In some embodiments, the query is executed against the initial set of data presented in the user interface. In general, the executing of the query may include matching, comparing, and grouping, in a variety of combinations, characteristics of the data items in the initial set of data as specified by the query statement. In this manner, execution of the query may operate to filter the initial data to provide a result that only includes data items similar to or the same as that in the selected sub-set or excludes data items like or the same as those in the selected sub-set of data items. In some embodiments, the query may be executed against a collection of data not limited to the initial set of data. For example, the collection of data pertinent to the user may have changed in an interim time period from an initial search that produced the initial data set. As such, the execution of the derived query is executed against an updated collection of data that is not the same as or limited to the initial data set.

The result of the query execution may be presented to the user in the user interface, in some embodiments. In some instances, the query result may be presented in one or more other user interfaces. In some embodiments, the user may further select data items from the query result for additional query statement and query function determinations such that further filtering of the result data may be accomplished, as facilitated by the user interface in accordance with embodiments herein.

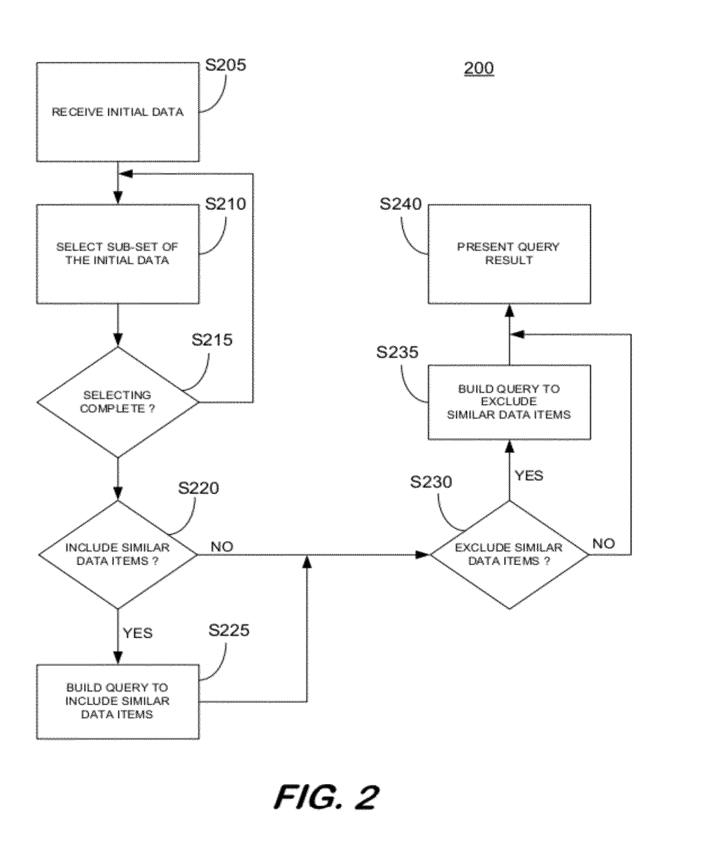

FIG. 2 is an illustrative example of a process 200 that depicts a method according to some embodiments herein. At S205, an initial set of data is presented to a user as described hereinabove. At S210, the user selects one or more data items, a sub-set of the initial data set, through, on, in, or via the user interface. The selection of the particular data items of the sub-set of data may be implemented by choosing the representations of the initial data set through, on, in, or via the user interface. The selection process may utilize a mouse or other input pointing device, a touchscreen, and other touch-based input methods. Notably, text input may not be useful for entering or otherwise indicating the selected sub-set of data.

At S215, a determination is made whether the user has completed the selecting of the data items to be included in the sub-set of data. In some embodiments, the conclusion of the selection process may be indicated by a predetermined lapse in time since the last selection of data items to include in the sub-set of data, an “end of selecting” notification provided or initiated by the user via the user interface, selecting a maximum number of data items (in some embodiments, there is no limit on the number of data items that may be selected), and other factors. If the selecting of sub-set data items is not complete, then the selected data items are at least temporarily stored and process 200 returns to a point before operation S210 to accommodate further selections. In the instance the selecting process is complete, then the process proceeds to operation S220.

At S220, a determination is made whether the query statement(s) or function(s) should include results similar to or the same as the selected sub-set data. In the instance the result of the query statement(s) and functions(s) should include like data items, then process 200 proceeds to operation S225 where the appropriate query statement(s) and functions(s) are determined and built based on the selected sub-set of data. In the instance the result of the query statement(s) and functions(s) should not include (i.e., exclude) data items like the selected sub-set of data, then process 200 proceeds to operation S230 from S220.

At S230, a determination is made whether the query statement(s) or function(s) should include results dissimilar to the selected sub-set data. In the instance the result of the query statement(s) and functions(s) should not include like data items, then process 200 proceeds to operation S235 where the appropriate query statement(s) and functions(s) are determined and built based on the selected sub-set of data such that data items similar to the selected sub-set of data are excluded from the query result. In the instance the result of the query statement(s) and functions(s) should not exclude data items like the selected sub-set of data as determined at S230, then process 200 proceeds to operation S240 from S230 where the query is executed and the result is presented to the user via the user interface.

In accordance with process 200 and some other embodiments, a query statement or function may be derived from an indication of a selection of a sub-set of initial data presented in a user interface, where the query statement may include filter functions to include data items similar to the selected sub-set, filter functions to exclude items similar to the selected sub-set, and combinations thereof.

In some embodiments, process 200 may be traversed one or more times by a user, in order to refine the results obtained by the user. In some aspects, process 200 may be traversed multiple times as a user further refines the results based on the selection of sub-sets of previous search results. In some regards, the user may be able to efficiently obtain relevant search results by recursive filters implemented by the methods herein. As illustrated, the user need not have knowledge of query statements and structures in order to obtain desired result since the user may operate or interact directly with results provided the user interface, in contrast to command lines and query language data structures.

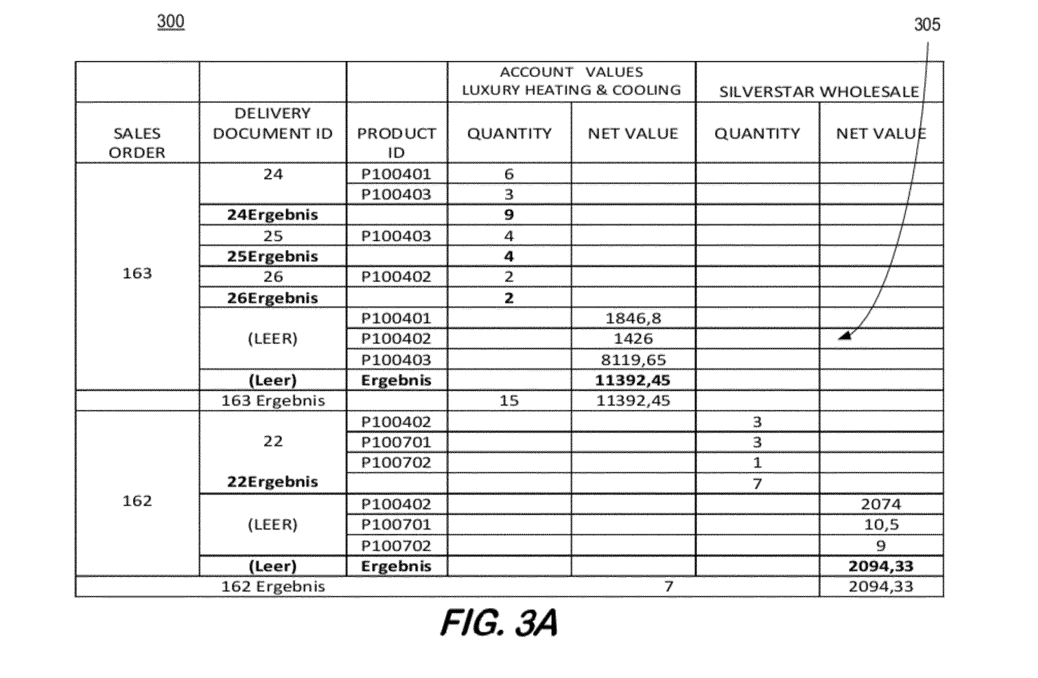

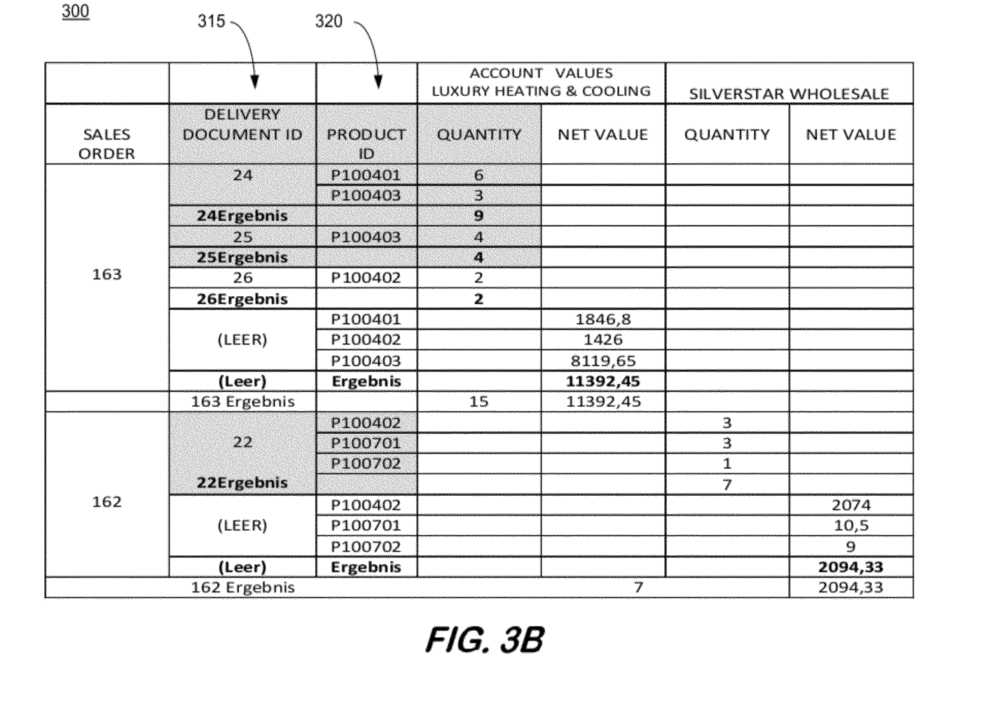

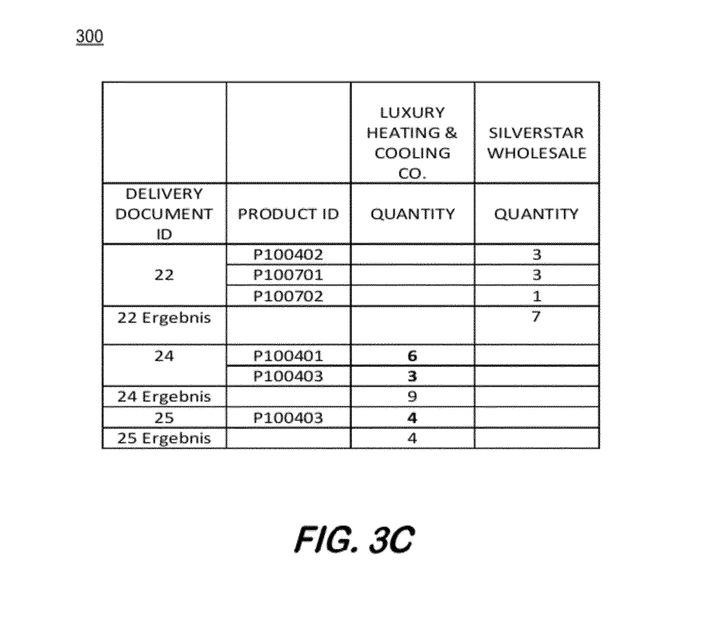

FIGS. 3A-3C provide an illustrative example of querying data using filters derived from user indicated selections of data made via a user interface, in accordance with some embodiments herein. In the particular example of FIG. 3A, a user interface 300 is shown. In some embodiments, the example of FIGS. 3A-3C may be a presentation of a Microsoft Excel™ pivot table by a frontend device, machine, or system. User interface 300 includes a presentation of a collection of data. In this example, the collection of data relates to business data, including sales orders, delivery document IDs, and associated product IDs. It is noted that the particular data, data types, and data values may vary from those particularly depicted in FIG. 3A.

FIG. 3B shows a number of data items that have been selected by a user, as indicated by the shaded area of the user interface. In this example, the selected sub-set 310 and 315 of the initial data set 305 includes data values associated with the Delivery Document ID data type and the Product ID data type.

Based on the selected sub-set of data items selected via user interface 300 in FIG. 3B, a query is determined and constructed to further filter the collection of data 305 of FIG. 3A. In the present example, the selected sub-set of data items is desired by the user. Accordingly, the query will operate to provide a result including data items of the type like the selected sub-set.

In some embodiments, the query is executed by a system, device, service, application, or program. The system, device, service, application, or program that builds and executes the query may be distinct from the user interface 300 or in some embodiments, an associated aspect of such system, device, service, application, or program.

FIG. 3C shows the result of the query derived from the selected sub-set of data items in FIG. 3B and presented in the user interface 300 of FIG. 3C. As illustrated, the result of the query execution is depicted in the user interface. The result here includes data items similar to (e.g., the same in the present example) the selected sub-set of data items shown in FIG. 3B. In the illustrated example, the “Quantity” values for “Silverstar Wholesale Corp” are provided in the result, even though the user did not select these values. The “Quantity” column header was included in the result set of data and no filters were invoked to exclude “Silverstar Wholesale Corp”. In some embodiments, decisions and determinations of the queries constructed and executed herein may be determined, in part, based on a knowledge or insight into previous searches and queries and rules governing the determination of the queries.

In some embodiments, filters implemented herein may be expressed in WHERE clauses of queries given in SQL or, as in the case of the pivot table example above, in MDX (Multidimensional Expressions query language). It is noted that embodiments herein are not restricted to these particular implementations.

In the example of FIGS. 3A-3C, it is seen that since three Delivery Document IDs are part of the selection, a WHERE condition of the initial query may be augmented by an expression such as:

. . . AND DLVDOCID IN {22, 24, 25}

Also, an existing filter with regard to DLVDOCID would be removed to narrow the query results to the selected items.

The reverse operation, on the other hand, would just find out that Delivery Document IDs are part of the selection and therefore delete any existing restrictions for DLVDOCID. Note that if the original query already had a filter with regard to DLVDOCID, the reverse operation would not reestablish this filter. This way the result set may turn out even larger than with the original query.

It is further seen from the example of FIGS. 3A-3C that a second effect of the operation goes beyond WHERE clauses. For example, the ROW axis of the result shows three dimensions, Sales Order, Delivery Document ID, and Product ID. Since the latter two are selected, Sales Order is removed from the query. Alternatively, the COLUMNS axis, where no dimension is selected, remains unchanged. This desired action may be implemented in a SELECT part of a SQL query, and in the ON ROWS or ON COLUMNS part of a MDX query.

As demonstrated by the example of FIGS. 3A-3C, the user does not enter any text, such as a query statement. Moreover, the user need not know how to or even understand how to define a query statement of function and/or create a query statement or function since the query is automatically derived based on and in response to the user's selection of the sub-set of data selected directly from the user interface. The selection of the sub-set of data directly through the user interface using visual, non-textual entry methods provides the basis for the determination and construction of the query. As such, the user need not have an understanding of a query statement structure, format, parameters, or constraints.

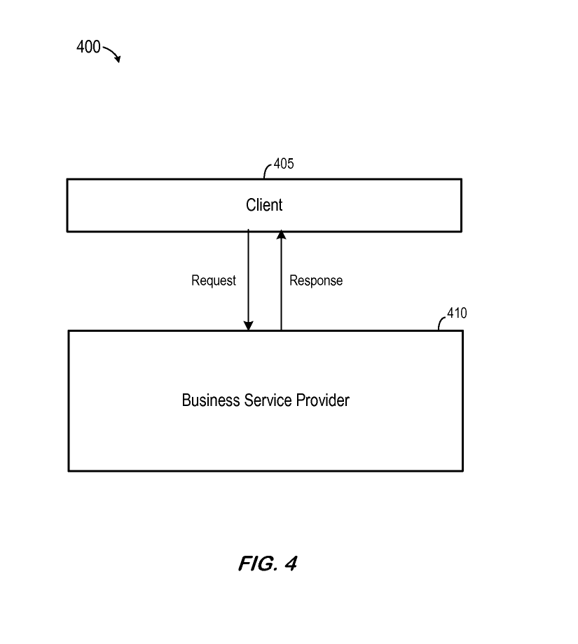

FIG. 4 is a block diagram of a system 400 according to some embodiments. In this case, a business service provider 405 might host and provide business services for a client 410. For example, business service provider 405 may receive requests from the client 410 and provide responses to the client 410 via a service-oriented architecture such as those provided by SAP Business ByDesign®. Note that the business service provider 410 might represent any backend system, including backend systems that belong to the client 405, those that belong to (or are administered by) service providers, those that are web services, etc.

Client 410 may be associated with a Web browser to access services provided by business process platform 405 via HyperText Transport Protocol (HTTP) communication. For example, a user may manipulate a user interface of client 405 to select data items that indicate an instruction (e.g., “show me just this data”). Client 410, in response, may transmit a corresponding HTTP service request to the business service provider 405 as illustrated. A service-oriented architecture may conduct any processing required by the request (e.g., generating queries and executing the queries against a collection of data) and, after completing the processing, provides a response (e.g., search results) to client 410. Client 410 may comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

In some aspects, FIG. 4 represents a logical architecture for describing processes according to some embodiments, and actual implementations may include more or different elements arranged in other manners. Moreover, each system described herein may be implemented by any number of devices in communication via any number of other public and/or private networks. Two or more of the devices herein may be co-located, may be a single device, or may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Client 410 may provide a user interface for presenting collections of data, such as search results, to a user and receive an indication of a selection of one or more of the data items presented in the user interface. In some embodiments, the data may be associated with data structures hosted by business service provider 405. The entry of a selection of data into a user interface of client 405 may, in some cases, be completely accomplished without entry of text by the user and without using additional tools or other screens. Instead, the entry of the user's selections of data items is made by the user directly manipulating the data presented in the user interface. For example, the user may highlight user interface data items using a mouse or other input pointing device (e.g., trackpad) to directly select a number of data items from a previous search result. The backend system, business service provider 405, may in turn use the selected data items to derive a query that returns a result including data items similar to the selected items, a result excluding data items similar to the selected items, and combinations thereof. The determination of the query and execution of same may be automatically performed without further input by the user. The result(s) of the query may be presented to the user in the user interface used to present the initial data to the user.

Accordingly, a method and mechanism for efficiently and automatically creating and executing a query based on a selection of data items selected via a user interface are provided by some embodiments herein.

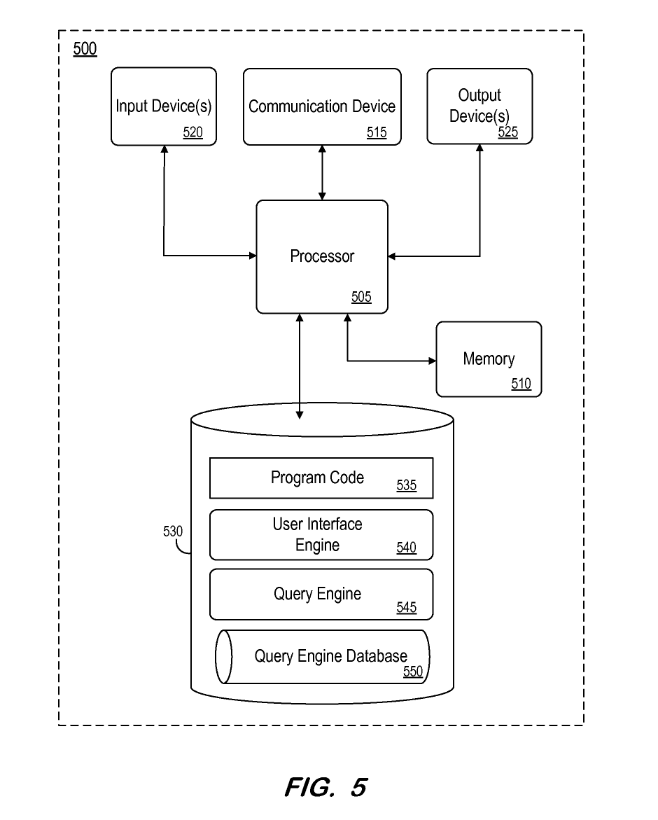

FIG. 5 is a block diagram overview of a user interface filter platform 500 according to some embodiments. The user interface filter platform 500 may be, for example, associated with any of the devices described herein. The user interface filter platform 500 comprises a processor 505, such as one or more commercially available Central Processing Units (CPUs) in form of one-chip microprocessors or a multi-core processor, coupled to a communication device 515 configured to communicate via a communication network (not shown in FIG. 6) to a front end client (not shown in FIG. 6). Device 500 may also include a local memory 510, such as RAM memory modules. Communication device 515 may be used to communicate, for example, with one or more client devices or business service providers. The user interface filter platform engine 500 further includes an input device 520 (e.g., a mouse and/or keyboard to enter content) and an output device 525 (e.g., a computer monitor to display a user interface element).

Processor 505 communicates with a storage device 530. Storage device 530 may comprise any appropriate information storage device, including combinations of magnetic storage devices (e.g., a hard disk drive), optical storage devices, and/or semiconductor memory devices.

Storage device 530 stores a program 535 and/or user interface engine application 540 for controlling the processor 505 and query engine application 545 for determining, constructing, and executing queries. Processor 505 performs instructions of the programs 535, 540, 545 and thereby operates in accordance with any of the embodiments described herein. For example, processor 505 may create a user interface with support from user interface engine 540 to present search results and to receive a selection of one or more data items of the presented search results in a graphical user interface, wherein the selected data items are used to determine a query. Processor 505 may also automatically determine the query with the support of query engine application 545. Programs 535, 540, and 545 may be stored in a compressed, uncompiled and/or encrypted format. Programs 535, 540, and 545 may furthermore include other program elements, such as an operating system, a database management system, and/or device drivers used by the processor 505 to interface with peripheral devices.

In some embodiments (such as shown in FIG. 5), the storage device 530 stores a query engine database 550 to facilitate the determination and construction of queries based on selected user interface data items. The query database may include data structures, rules, and conditions for determining a query based on user interface selections as described herein.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to web browser displays, note that embodiments may be associated with other types of user interface displays. For example, a user interface may be associated with a portable device such as a smart phone or Personal Digital Assistant (PDA), with a user interface element.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
presenting an initial set of data in a user interface;
receiving an indication of a selection of a sub-set of the initial set of data, the selection made by directly selecting a portion of the initial set of data in the user interface;
automatically determining, by a processor, at least one query statement based on the received indication of the selection of the sub-set of the initial set of data; and
executing, by the processor, the at least one query statement against a collection of data to produce a result set of data.

2. The method of claim 1, wherein the at least one query statement functions to include data items similar to the selection of the sub-set of the initial set of data in the result set of data.

3. The method of claim 1, wherein the at least one query statement functions to exclude data items similar to the selection of the sub-set of the initial set of data in the result set of data.

4. The method of claim 1, wherein the at least one query statement functions to include a data item similar to the selection of the sub-set of the initial data and to exclude a data item similar to the selection of the sub-set of the initial set of data in the result set of data.

5. The method of claim 1, further comprising presenting the result set of data in the user interface.

6. The method of claim 1, further comprising automatically building, by the processor, the at least one query statement in a format compatible for the executing of the at least one query statement.

7. The method of claim 1, wherein the selection of the sub-set of the initial set of data includes selecting at least one of a characteristic and a value of a characteristic-value pair of the initial set of data presented in the user interface.

8. The method of claim 1, wherein the collection of data includes the initial data.

9. The method of claim 1, further comprising:
receiving an indication of a selection of a sub-set of the result set of data, the selection made by directly selecting a portion of the result set of data in the user interface;
automatically determining, by the processor, at least one query statement based on the received indication of the selection of the sub-set of the result set of data;
executing, by the processor, the at least one query statement against a second collection of data to produce a second result set of data.

10. The method of claim 9, wherein the second collection of data includes the result set of data.

11. The method of claim 1, further comprising storing the result set of data.

12. A computer-readable medium storing program code executable by a computer to:
present an initial set of data in a user interface;
receive an indication of a selection of a sub-set of the initial data, the selection made by directly selecting a portion of the initial set of data in the user interface;
automatically determine, by a processor, at least one query statement based on the received indication of the selection of the sub-set of the initial set of data; and
execute, by the processor, the at least one query statement against a collection of data to produce a result set of data.

13. The medium of claim 12, wherein the at least one query statement functions to include data items similar to the selection of the sub-set of the initial set of data in the result set of data or to exclude data items similar to the selection of the sub-set of the initial data in the result set of data.

14. The method of claim 12, wherein the at least one query statement functions to include a data item similar to the selection of the sub-set of the initial set of data and to exclude a data item similar to the selection of the sub-set of the initial set of data in the result set of data.

15. The medium of claim 12, further comprising program code executable by a computer to present the result set of data in the user interface.

16. The medium of claim 12, further comprising program code executable by a computer to automatically build the at least one query statement in a format compatible for the executing of the at least one query statement.

17. The medium of claim 12, wherein the selection of the sub-set of the initial set of data includes selecting at least one of a characteristic and a value of a characteristic-value pair of the data presented in the user interface.

18. The medium of claim 12, wherein the collection of data includes the initial set of data.

19. The medium of claim 12, further comprising program code executable by a computer to:
receive an indication of a selection of a sub-set of the result set of data, the selection made by directly selecting a portion of the result set of data in the user interface;
automatically determine at least one query statement based on the received indication of the selection of the sub-set of the result set of data;
execute the at least one query statement against a second collection of data to produce a second result set of data.

20. The medium of claim 19, wherein the second collection of data includes the result set of data.

21. The medium of claim 12, further comprising program code executable by a computer to:
store the result set of data.

22. A system, comprising:
an user interface engine to display a user interface to present an initial set of data in a user interface and to receive an indication of a selection of a sub-set of the initial data, the selection made by directly selecting a portion of the initial set of data in the user interface; and
a query engine to:
automatically determine at least one query statement based on the received indication of the selection of the sub-set of the initial set of data; and
execute, automatically, the at least one query statement against a collection of data to produce a result set of data.

23. The system of claim 22, wherein the at least one query statement functions to include data items similar to the selection of the sub-set of the initial set of data in the result set of data or to exclude data items similar to the selection of the sub-set of the initial set of data in the result set of data.

24. The system of claim 22, wherein the user interface engine further presents the result set of data in the user interface.

25. The system of claim 22, wherein:
the user interface engine further receives an indication of a selection of a sub-set of the result set of data, the selection made by directly selecting a portion of the result set of data in the user interface; and
the query engine further:
automatically determines at least one query statement based on the received indication of the selection of the sub-set of the result set of data; and
executes the at least one query statement against a collection of data to produce a second result set of data.

26. The system of claim 22, further comprising a memory to store the result set of data.
